(19) United States
(12) Patent Application Publication
(10) Pub. No.: US 2014/0287800 A1
(43) Pub. Date: Sep. 25, 2014

(54) PROTECTIVE SHELL AND CHARGING DEVICE COMBINATION FOR MOBILE PHONE

(71) Applicant: OXTI CORPORATION, Taipei (TW)

(72) Inventor: Chih Feng HO, Taipei (TW)

(73) Assignee: Oxti Corporation, Taipei (TW)

(21) Appl. No.: 13/846,955

(22) Filed: Mar. 19, 2013

(51) Int. Cl. H04B 1/38; H04M 1/02; H02J 7/00

(52) U.S. Cl. CPC H04B 1/3883; H02J 7/0042; H04M 1/0254; H04B 1/3888
USPC 455/573

(57) ABSTRACT

A protective shell and charging device combination includes a shell having a base member for attaching to an electrical facility, an attaching device attached to the base member of the shell, a charging device, and another attaching device attached to the charging device for engaging with the attaching device of the base member of the shell and for detachably attaching the charging device to the shell. The attaching devices include one or more magnetic attractive members for attracting or acting with each other and for detachably attaching the charging device to the shell. The shell includes a compartment formed by the base member, an upper member and a lower member for engaging with the mobile phone.

### BACKGROUND OF THE INVENTION

1. Field of the Invention

The present invention relates to a protective shell and charging device combination for portable or mobile phones, and more particularly to a protective sheath or shell and charging device combination including a protective sheath or shell for attaching or mounting or securing onto a portable or mobile phone for shielding and protecting the portable or mobile phone and including a portable charging device or facility for attaching or mounting or securing onto the portable or mobile phone with the protective sheath or shell and for easily and quickly and readily charging the portable or mobile phone or for providing an electric power to the portable or mobile phone.

2. Description of the Prior Art

Portable or mobile phones have been widely used today, and various kinds of typical charging devices or apparatuses or facilities have been developed and provided for charging the portable or mobile phones or for providing an electric power to the portable or mobile phones.

For example, U.S. Patent Application No. 2002/0147036 to Taguchi et al., and U.S. Patent Application No. 2007/0123315 to Williams JR. disclose two of the typical portable or mobile phones each comprising a typical charging device or apparatus or facility for electrically connecting or coupling to the portable or mobile phones or for providing an electric energy or power to the portable or mobile phones.

However, the typical charging devices or apparatuses or facilities are normally separated from the portable or mobile phones and received or carried in a pocket or purse or suitcase or the like, and may not be attached or mounted or secured or coupled or anchored to the portable or mobile phones such that the typical charging devices or apparatuses or facilities may not be carried with the users.

For example, when the previous batteries or power sources for the portable or mobile phones have been consumed, the users may have to open their pockets or purses or suitcases in order to search and find the required spare batteries or power sources or charging devices or apparatuses or facilities and then to electrically connect or couple the spare batteries or power sources or charging devices or apparatuses or facilities to the portable or mobile phones, and it thus takes time to search and find and couple the required spare batteries or power sources or charging devices or apparatuses or facilities to the portable or mobile phones.

Various kinds of typical protective shells or sheaths or shields or covers have also been developed and provided for attaching or mounting or securing onto the portable or mobile phone and for shielding and protecting the portable or mobile phone, however, the typical protective shells or sheaths or shields or covers may only be used for attaching or mounting or securing onto the portable or mobile phone, but may not be used for attaching or mounting or securing the other charging devices or apparatuses or facilities onto the portable or mobile phones.

The present invention has arisen to mitigate and/or obviate the afore-described disadvantages of the conventional portable or mobile phones and charging devices problems.

### SUMMARY OF THE INVENTION

The primary objective of the present invention is to provide a protective shell and charging device combination including a protective sheath or shell for attaching or mounting or securing onto a portable or mobile phone for shielding and protecting the portable or mobile phone and including a portable charging device or facility for attaching or mounting or securing onto the portable or mobile phone with the protective sheath or shell and for easily and quickly and readily charging the portable or mobile phone or for providing an electric power to the portable or mobile phone.

In accordance with one aspect of the invention, there is provided a protective shell and charging device combination for an electrical facility comprising a protective shell including a compartment formed therein and defined by a base member, an upper member, a lower member, and two side members for attaching and receiving and engaging with the electrical facility in the compartment of the protective shell, a first attaching device attached to the base member of the protective shell, a charging device, and a second attaching device attached to the charging device for engaging with the first attaching device and for detachably attaching the charging device to the protective shell.

The first attaching device includes at least one first magnetic attractive member engaged into the base member of the shell, and the second attaching device includes at least one second magnetic attractive member engaged into the charging device for acting with the first magnetic attractive member of the base member of the shell, and for detachably attaching the charging device to the shell with the magnetic attractive members.

The first attaching device includes a first anchoring mechanism provided in the base member of the shell, and the second attaching device includes a second anchoring mechanism provided in the charging device for engaging with the first anchoring mechanism of the base member of the shell and for detachably locking the charging device to the shell.

The first anchoring mechanism is an orifice formed in the base member of the shell, and the second anchoring mechanism is a latch extended from the charging device for selectively engaging with the orifice of the base member of the shell. The shell includes a plug extended into the compartment of the shell for engaging with a socket opening of the electrical facility and for selectively and electrically connecting or coupling the electrical facility to the protective shell.

The shell includes at least one projection extended into the orifice of the base member of the shell, and the latch includes an engaging element for engaging into the orifice of the shell, and includes at least one notch formed in the engaging element for receiving and engaging with the projection of the shell and for allowing the engaging element to be fitted and engaged the orifice of the shell.

The shell includes a stud extended therefrom, and the engaging element is formed or provided or disposed or secured or supported on the stud and having an outer diameter greater than that of the stud and having a shape similar or corresponding to or identical to that of the orifice of the protective shell. The orifice of the base member of the shell is a circular shaped orifice, and the engaging element is a circular shaped engaging element for selectively and snuggly fitting or engaging with the circular orifice of the base member of the shell.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a protective shell and charging device combination in accordance with the present invention for a portable or mobile phone;

FIG. 2 is another exploded view of the protective shell and charging device combination;

FIG. 3 is a perspective view of the protective shell and charging device combination;

FIG. 4 is another perspective view similar to FIG. 3, illustrating the operation of the protective shell and charging device combination;

FIG. 5 is a cross sectional view of the protective shell and charging device combination, taken along lines 5-5 of FIG. 3; and

FIG. 6 is a plan schematic view illustrating the operation of the protective shell and charging device combination.

### DETAILED DESCRIPTION OF THE PREFERRED EMBODIMENT

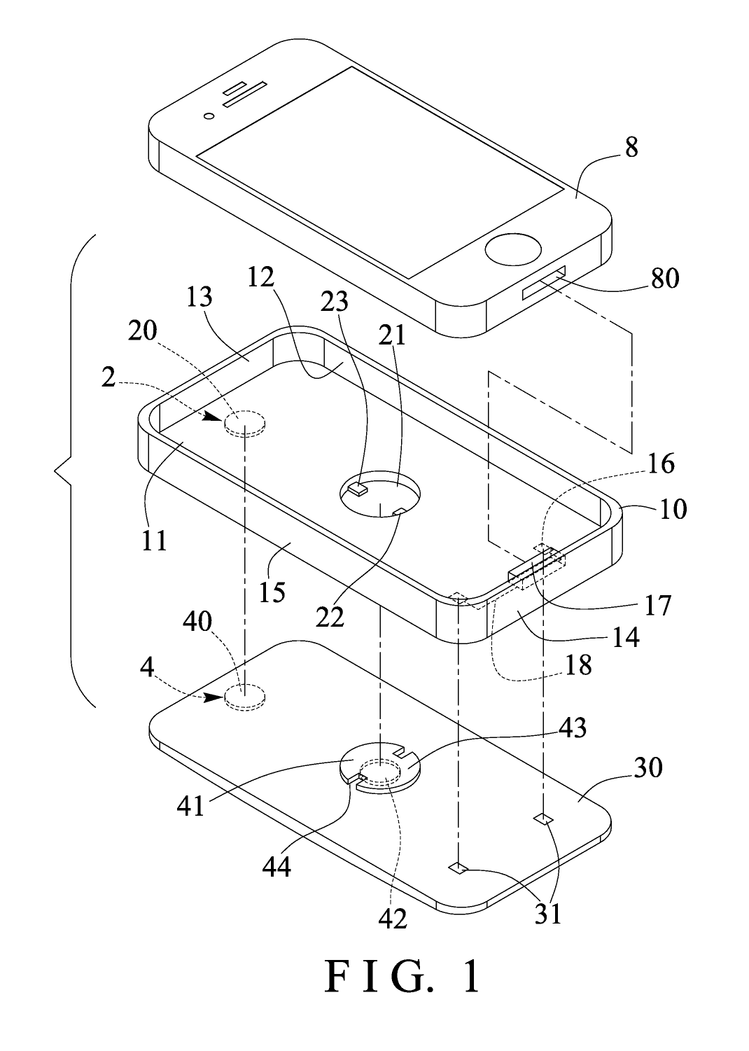

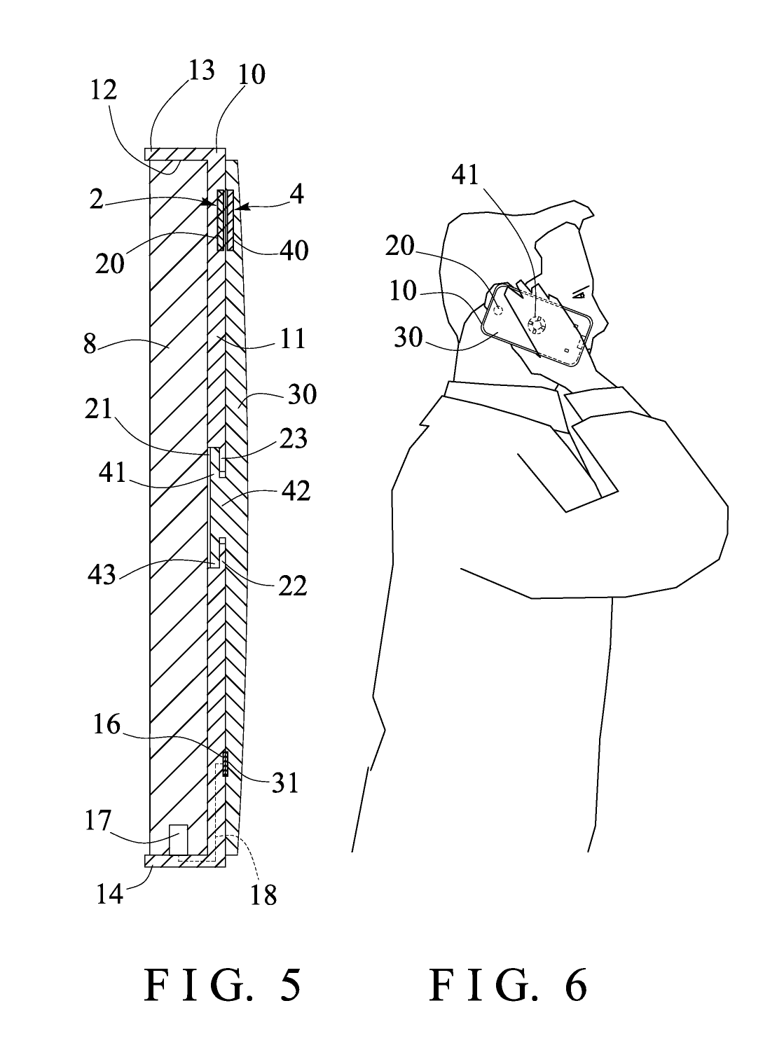

Referring to the drawings, and initially to FIGS. 1-5, a protective shell and charging device combination in accordance with the present invention comprises a protective sheath or shield or shell 10 including a bottom or base wall or panel or board or plate or member 11 for attaching or mounting or securing onto or engaging with an electrical apparatus or facility 8, such as a portable or mobile phone 8 (FIGS. 1, 5), and/or including a chamber or compartment 12 formed in the protective sheath or shield or shell 10 and formed or defined by the base wall or panel or board or plate or member 11, an upper plate or member 13, a lower or bottom plate or member 14, and/or two opposite side plates or members 15 for receiving or engaging with or anchoring or retaining the portable or mobile phone 8 in the compartment 12 of the protective shell 10 with a force-fitted engagement or the like, in which the portable or mobile phone 8 includes a socket opening 80 formed or provided therein (FIG. 1).

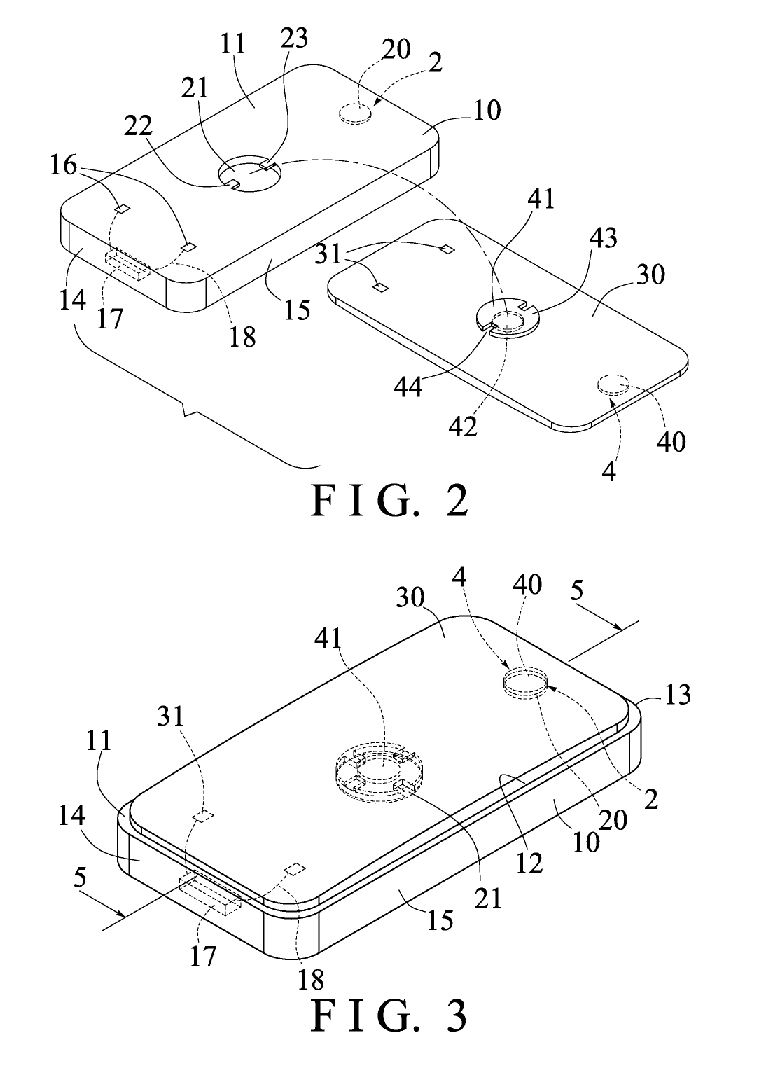

The protective shell 10 includes one or more (such as two) contacts or electrodes or terminals 16 disposed or provided or attached or mounted or secured or engaged therein, such as engaged in the base member 11 of the protective shell 10 and extended or located or faced or directed or exposed outwardly and rearwardly or away from the base member 11 (FIGS. 2 and 5), and includes a plug 17 formed or provided or attached or mounted or secured thereto, such as provided on the lower or bottom member 14 and extended into the compartment 12 of the protective shell 10 and electrically connected or coupled to the contacts or terminals 16 with electric cables or wires 18 or the like, for plugging or engaging into or with the socket opening 80 of the portable or mobile phone 8 and thus for electrically connecting or coupling to the portable or mobile phone 8 and for further solidly and firmly or stably anchoring or retaining or mounting or securing the portable or mobile phone 8 within the compartment 12 of the protective shell 10.

The protective shell 10 further includes an attaching or mounting or securing or engaging or anchoring or retaining device 2 having one or more (such as two) magnets or magnetic attractive members 20 disposed or attached or mounted or secured or engaged into the protective shell 10, particularly into the base member 11 of the protective shell 10 for attracting or acting with the portable or mobile phone 8 and for detachably attaching or mounting or securing onto the mobile phone 8. The attaching device 2 and/or the protective shell 10 may further include another mounting or securing or engaging or retaining or anchoring member or element or mechanism 21, such as a circular hole or opening or passage or orifice 21 formed in or through the base member 11 of the protective shell 10, and one or more (such as two) keys or protrusions or jaws or pawls or projections 22, 23 formed or provided therein and extended into the orifice 21 of the base member 11 of the protective shell 10 (FIGS. 1 and 2).

It is to be noted that, without the attaching device 2, the protective shell 10 may also be attached or mounted or secured or disposed or engaged or anchored or retained or clamped onto the mobile phone 8 with the force-fitted engagement with or by the upper member 13 and the lower or bottom member 14, and/or the side members 15, for suitably shielding and protecting the mobile phone 8 and for preventing the mobile phone 8 from being scrubbed or scraped by the other objects or the like. The protective shell 10 may be made of soft or resilient materials selected from rubber, plastic, silicon, or composite materials or the like for easily and quickly and readily engaging onto the portable or mobile phone 8 and for softly or resiliently engaging with the portable or mobile phone 8.

The protective shell and charging device combination further includes a portable electric power source or battery or charging apparatus or facility or device 30 having another attaching or mounting or securing or engaging or anchoring or retaining device 4 which includes one or more (such as two) magnets or magnetic attractive members 40 disposed or attached or mounted or secured or engaged into the portable charging apparatus or facility or device 30 for directing toward or aligning with the magnets or magnetic attractive members 20 of the attaching device 2 of the protective shell 10 and for attracting or acting with the magnets or magnetic attractive members 20 of the attaching device 2 of the protective shell 10 and for detachably attaching or mounting or securing the charging device 30 onto the protective shell 10.

Similarly, the attaching device 4 and/or the charging device 30 may further include another mounting or securing or engaging or anchoring or retaining members or elements, such as another mounting or securing or engaging or retaining or anchoring member or element or mechanism 41, such as a latch 41 extended rearwardly and outwardly from the charging device 30 for selectively engaging with the anchoring mechanism or orifice 21 of the attaching device 2 and/or the protective shell 10; i.e., the anchoring mechanism or latch 41 of the attaching device 4 and/or the charging device 30 may be meshed or locked or latched or engaged with the anchoring mechanism or orifice 21 of the attaching device 2 and/or the protective shell 10 for detachably attaching or mounting or securing the charging device 30 onto the protective shell 10 and thus for allowing the charging device 30 to be easily or suitably carried with the users together with the protective shell 10.

For example, the anchoring mechanism or latch 41 of the attaching device 4 and/or the charging device 30 includes a shank or stem or stud 42 extended rearwardly and outwardly from the charging device 30, and an engaging member or element 43, such as a circular engaging element 43 formed or provided or attached or mounted or secured on the stud 42 and having an outer diameter greater than that of the stud 42 and having a shape similar or corresponding to or identical to that of the orifice 21 of the protective shell 10 for snuggly fitting or engaging into or with the orifice 21 of the protective shell 10, and the engaging element 43 includes one or more (such as two) recesses or depressions or notches 44 formed therein (FIGS. 1 and 2) for receiving or engaging with the projections 22, 23 of the protective shell 10 and thus for allowing the engaging element 43 to be fitted or engaged into the orifice 21 of the protective shell 10.

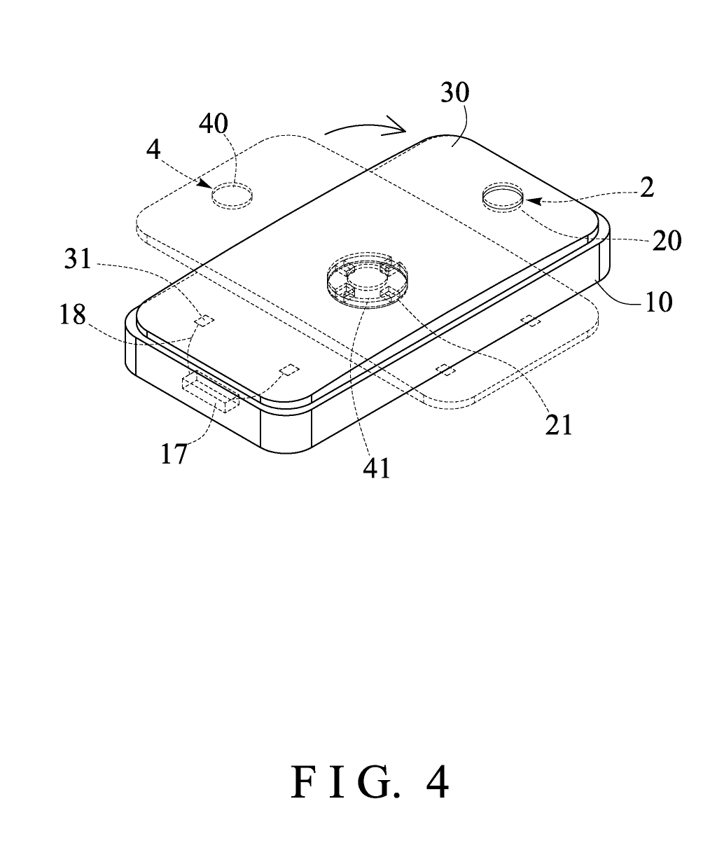

As shown in dotted lines in FIG. 4, after the projections 22, 23 of the protective shell 10 are extended or engaged into or through the notches 44 of the anchoring mechanism or latch 41 of the attaching device 4 and/or the charging device 30 and after the engaging element 43 is engaged into the orifice 21 of the protective shell 10, the charging device 30 is substantially tilted or inclined or perpendicular to the protective shell 10 at the releasing position, and may then be pivoted or rotated relative to protective shell 10 in order to offset or disengage or separate the projections 22, 23 of the protective shell 10 from the notches 44 of the latch 41 of the charging device 30 as shown in dotted lines in FIG. 3, and to align the charging device 30 with the protective shell 10 at the parallel working or latching or locking position as shown in solid lines in FIG. 4, and so as to solidly and stably and firmly attach or mount or secure or anchor or retain or position or latch or lock the charging device 30 to the protective shell 10.

After the charging device 30 is attached or mounted or secured or anchored or retained or positioned or latched or locked to the protective shell 10 at the parallel working or latching or locking position (FIGS. 3-6), the one or more (such as two) contacts or terminals or electrodes 31 of the charging device 30 may be aligned and contacted or engaged with the contacts or terminals 16 of the protective shell 10 for supplying the electric power or energy from the charging device 30 to the portable or mobile phone 8 with the plug 17, and thus for allowing the charging device 30 to be easily and readily and suitably used and carried with the users as best shown in FIG. 6. The structure or configuration and/or the function or operation of the battery or charging device 30 is not related to the present invention and will not be described in further details.

In operation, as shown in FIGS. 2-5, the protective shell 10 may be easily and quickly and readily attached or mounted or secured or anchored or retained to the mobile phone 8, or the mobile phone 8 may be easily and quickly and readily engaged with or into the compartment 12 of the protective shell 10, and the charging device 30 may be easily and quickly and readily attached or mounted or secured or anchored or retained to the protective shell 10 with the magnetic attractive members 20, 40 and/or the anchoring mechanisms 21, 41 of the attaching devices 2, 4 and/or of the protective shell 10 and the charging device 30, and thus for allowing the charging device 30 to be easily or suitably used and carried with the users (FIG. 6). The magnetic attractive members 20, 40 of the attaching devices 2, 4 include different poles for attracting or acting with each other.

Accordingly, the protective shell and charging device combination in accordance with the present invention includes a protective sheath or shell for attaching or mounting or securing onto a portable or mobile phone for shielding and protecting the portable or mobile phone and including a portable charging device or facility for attaching or mounting or securing onto the portable or mobile phone with the protective sheath or shell and for easily and quickly and readily charging the portable or mobile phone or for providing an electric power to the portable or mobile phone.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A protective shell and charging device combination for an electrical facility comprising:
a shell including a compartment formed therein and defined by a base member, an upper member, a lower member, and two side members for attaching and receiving and engaging with the electrical facility,
a first attaching device attached to said base member of said shell,
a charging device, and
a second attaching device attached to said charging device for engaging with said first attaching device and for detachably attaching said charging device to said shell.

2. The protective shell and charging device combination as claimed in claim 1, wherein said first attaching device includes at least one first magnetic attractive member engaged into said base member of said shell, and said second attaching device includes at least one second magnetic attractive member engaged into said charging device for acting with said at least one first magnetic attractive member of said base member of said shell, and for detachably attaching said charging device to said shell.

3. The protective shell and charging device combination as claimed in claim 1, wherein said first attaching device includes a first anchoring mechanism provided in said base member of said shell, and said second attaching device includes a second anchoring mechanism provided in said charging device for engaging with said first anchoring mechanism of said base member of said shell and for detachably locking said charging device to said shell.

4. The protective shell and charging device combination as claimed in claim 3, wherein said first anchoring mechanism is an orifice formed in said base member of said shell, and said second anchoring mechanism is a latch extended from said charging device for selectively engaging with said orifice of said base member of said shell.

5. The protective shell and charging device combination as claimed in claim 4, wherein said shell includes at least one projection extended into said orifice of said base member of said shell, and said latch includes an engaging element for engaging into said orifice of said shell, and includes at least one notch formed in said engaging element for receiving and engaging with said at least one projection of said shell and for allowing said engaging element to be fitted and engaged said orifice of said shell.

6. The protective shell and charging device combination as claimed in claim 5, wherein said shell includes a stud extended therefrom, and said engaging element is secured on said stud.

7. The protective shell and charging device combination as claimed in claim 5, wherein said orifice of said base member of said shell is a circular orifice, and said engaging element is a circular engaging element for selectively engaging with said circular orifice of said base member of said shell.

8. The protective shell and charging device combination as claimed in claim 1, wherein said shell includes a plug extended into said compartment of said shell for engaging with a socket opening of the electrical facility.
